(19) United States
(12) Patent Application Publication
(10) Pub. No.: US 2024/0416536 A1
(43) Pub. Date: Dec. 19, 2024

(54) FOLDING KNIFE WITH DIFFERENT UNLOCKING MODES

(71) Applicant: HUOXIONG GUANGZHOU TECHNOLOGY COMPANY LIMITED, GUANGZHOU (CN)

(72) Inventors: Yue DONG, Shanghai (CN); Liang ZHANG, Foshan (CN)

(73) Assignee: HUOXIONG GUANGZHOU TECHNOLOGY COMPANY LIMITED, GUANGZHOU (CN)

(21) Appl. No.: 18/353,793

(22) Filed: Jul. 17, 2023

(30) Foreign Application Priority Data
Jun. 16, 2023 (CN) 2023215404820

(51) Int. Cl. B26B 1/04

(52) U.S. Cl. CPC B26B 1/048

(57) ABSTRACT

The present invention relates to a folding knife with different unlocking modes, comprising a handle and a blade. The handle has a storage slot with a locking buckle installed therein, while the blade has a first locking groove and a second locking groove. The locking buckle includes a slider, a resetting component, and a first limiting column. The first limiting column is installed in the storage slot, the slider has a sliding groove, and the resetting component is located inside the sliding groove. The slider has a locking part with a protrusion extending from it, and a pull rod extending to the outside is also provided on the slider.

### CROSS-REFERENCE TO RELATED APPLICATIONS

The application claims priority to Chinese patent application No. 2023215404820, filed on Jun. 16, 2023, the entire contents of which are incorporated herein by reference.

### TECHNICAL FIELD

This disclosure relates to a folding knife with different unlocking modes.

### BACKGROUND

The statement herein only provides background information related to the present invention and does not necessarily constitute prior art.

The folding knife is one of the most popular EDC (everyday carry) products. In addition to the cutting function of the knife, consumers also pursue the convenience and playability of its use process, and are particularly keen on the structural design of blade unlocking. However, the unlocking methods of the folding knives available in the market are usually simple, which limits the flexibility, convenience and playability of operation for consumers.

Most existing folding knives use springs as the driving component to drive the unlocking mechanism to reset, which, for example, can be shown in the US patent U.S. Pat. No. 20,220,297322A1. However, as the internal space of folding knives is small, the size of the spring is usually small. During the disassembly, maintenance, and repair of folding knives, the spring is easy to lose, and users may find it difficult to purchase a completely matched spring with the right size and spring constant in the market for replacement.

For this reason, it is necessary to study a new technical solution to solve the above shortcomings.

### SUMMARY

To solve the defects and deficiencies of the prior art mentioned above, the present invention provides a folding knife with different unlocking modes. The knife has a slider with protrusions and pull rods extended thereon, allowing users to choose different unlocking methods according to their needs, which therefore improves the convenience of use and also increases the playability of the product. Additionally, the locking structure of the application provides reasonable design, stability, reliability and convenient assembly. Furthermore, the magnetic component is used as the resetting component as it is not easily lost and does not rust, which is convenient for users to carry out disassembly, maintenance, and repair.

To achieve the above objectives, the present invention adopts the following technical solution:

A folding knife with different unlocking modes comprises a handle and a blade that can be folded and stored inside the handle. The handle has a storage slot for the blade, and the storage slot is adjustably provided with a locking buckle, and the blade has a first locking groove and a second locking groove that are adapted to the locking buckle. Specifically:

The locking buckle includes a slider, a resetting component, and a first limiting column. The first limiting column is installed in the storage slot, and the slider is provided with a sliding groove extending forward and backward for the first limiting column, and the resetting component is arranged inside the sliding groove.

The slider is provided with a locking part that is adapted to the first locking groove and the second locking groove. The slider also has a protrusion extending obliquely upwards, and a pull rod is provided on the left and/or right side of the slider. The pull rod extends to the outside of the handle. The resetting component is composed of several mutually exclusive and arranged magnetic components.

In some embodiments, both the first locking groove and the second locking groove are strip-shaped grooves, and the strip-shaped grooves have a first limit wall surface. The locking part has a second limit wall surface that is adapted to the first limit wall surface.

In some embodiments, the storage slot is provided with a second limiting column for limiting the downward movement of the slider.

In some embodiments, the handle has a left plate and a right plate, with the left plate having a left outer liner and a left inner liner, and the right plate having a right outer liner and a right inner liner.

The left inner liner and the right inner liner are both hardware components, and both have a first avoidance hole for the first limiting column and a second avoidance hole for the second limiting column.

In some embodiments, the handle is provided with a third limiting column for limiting the upward rotation of the blade, and the blade is provided with a limit groove for the third limiting column.

In some embodiments, the protrusion is provided with friction patterns.

In some embodiments, the front and rear sides of the slider are both provided with pull rods, and the pull rods are connected to the slider through connecting screws.

Compared with the prior art, the present invention has obvious advantages and beneficial effects. Specifically, as can be seen from the above technical solution, it mainly extends a protrusion and a pull rod on the slider so that users can choose different unlocking methods according to their needs, which improves the convenience of use and increases the playability of the product. At the same time, the locking structure of this application is designed reasonably and has advantages of stability, reliability, and easy assembly. Moreover, the magnetic component is used as the resetting component as it is not easily lost and does not rust, which is convenient for users to carry out disassembly, maintenance, and repair.

In order to more clearly illustrate the structural features and functions of the present invention, the following is a detailed description of the present invention in conjunction with the attached figures and specific embodiments.

### BRIEF DESCRIPTION OF DRAWINGS

FIG. 1 shows a three-dimensional schematic diagram of an embodiment of the present invention;

FIG. 2 shows another three-dimensional schematic diagram of an embodiment of the present invention:

FIG. 3 shows a first exploded schematic diagram of an embodiment of the present invention:

FIG. 4 shows a second exploded schematic diagram of an embodiment of the present invention (unlocking status).

FIG. 5 shows a partially enlarged view of FIG. 4;

FIG. 6 shows a third exploded schematic diagram of an embodiment of the present invention (storage status);

FIG. 7 shows the cross-sectional schematic diagram of an embodiment of the present invention.

Description of the markings in the figures:

10. Handle; 11. Storage slot; 12. Second limiting column; 131. Left outer liner; 132. Left inner liner; 133. First avoidance hole; 134. Second avoidance hole; 141. Right outer liner; 142. Right inner liner; 15. Third limiting column; 16. Travel groove; 20. Blade; 21. First locking groove; 22. Second locking groove; 23. First limit wall surface; 24. Limit groove; 31. Slider; 311. Sliding groove; 312. Locking part; 3121. Second limit wall surface; 313. Protrusion; 32. Resetting component; 33. First limiting column; 34. Pull rod.

### DETAILED DESCRIPTION OF THE EMBODIMENTS

The following will provide a clear and complete description of the technical solution in this embodiment of the present invention in conjunction with the attached figures, and it is clear that the described embodiment is only a preferred embodiment of the present invention.

It should be noted that when a component is referred to as “fixed to” another component, it may be directly attached to another component or there may be a centered component. When a component is considered to be “connected to” another component, it may be directly connected to another component or there may also be a centered component. The terms “vertical”, “horizontal”, “left”, “right”, and similar expressions used in this article are for illustrative purposes only and do not necessarily represent the exclusive implementation method.

Unless otherwise defined, all technical and scientific terms used in this article have the same meanings as those commonly understood by those skilled in the technical field of the present invention. The terms used in the specification of the present invention in this article are only for the purpose of describing specific embodiments and are not intended to limit the present invention. The term “and/or” used in this article includes any and all combinations of one or more related listed items.

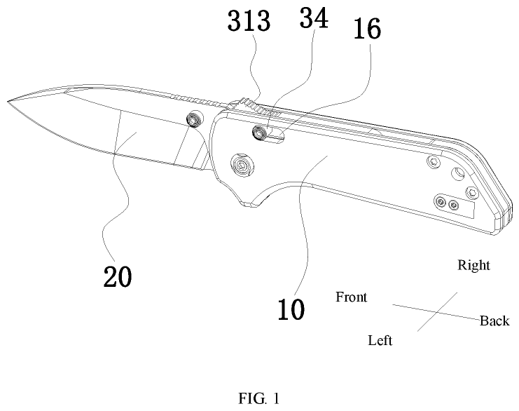

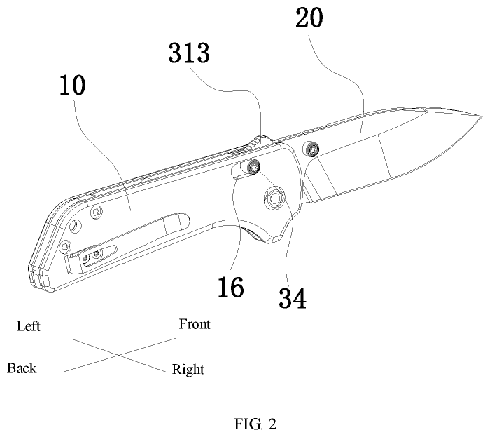

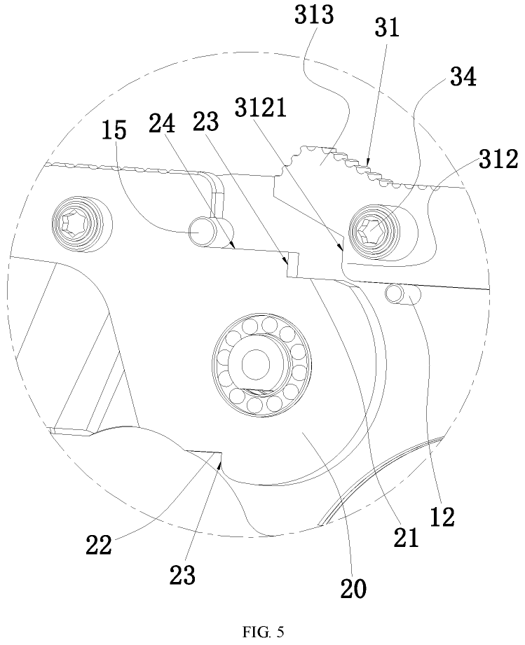

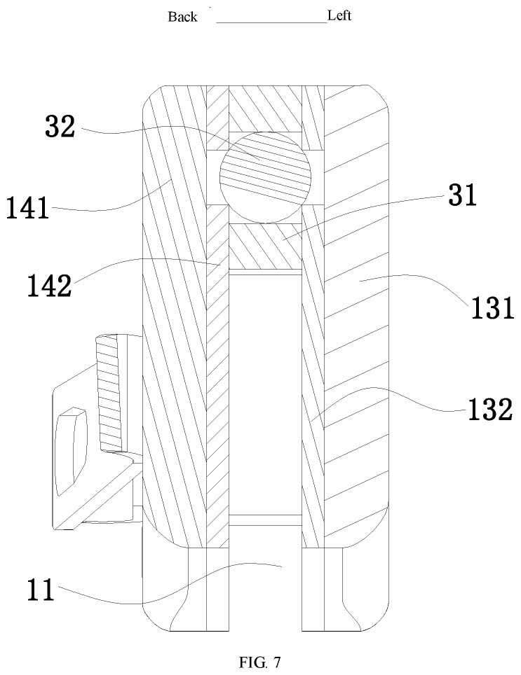

Referring to FIG. 1 to FIG. 7, a folding knife with different unlocking modes comprises a handle 10 and a blade 20 that can be folded and stored inside the handle 10. The handle 10 has a storage slot 11 for the blade 20, and the storage slot 11 is adjustably provided with a locking buckle. The blade 20 has a first locking groove 21 and a second locking groove 22 that are adapted to the locking buckle. Specifically:

The locking buckle includes a slider 31, a resetting component 32, and a first limiting column 33. The first limiting column 33 is installed in the storage slot 11 and the slider 31 is provided with a sliding groove 311 extending forward and backward for the first limiting column 33. The resetting component 32 is arranged inside the sliding groove 311.

The slider 31 is provided with a locking part 312 adapted to the first locking groove 21 and the second locking groove 22. The slider 31 further comprises a protrusion 313 extending obliquely upwards. The left and right sides of the slider 31 are provided with pull rod 34, which is correspondingly extended to the left and right sides of the handle 10. Generally, the pull rod 34 is connected to the slider 31 by connecting screws.

The resetting component 32 is a magnetic or spring element. In this embodiment, the resetting component 32 is preferably several (usually more than two) mutually exclusive and arranged magnetic elements, typically magnets. When the locking force (resetting force) of the slider 31 is too strong or too weak, the resetting component can be adjusted by reducing or increasing the magnetic elements. Meanwhile, when the knife needs maintenance or repair, etc., the operator can attach the magnetic elements to other easily attachable hardware components for storage, which makes it's easier to keep and less prone to loss than small parts such as springs. Additionally, there are no problems with rust affecting the resetting performance of the slider 31 when using magnetic elements.

Preferably, the protrusion 313 is designed with friction patterns to improve the unlocking feeling and to provide anti-slip function.

Both the first locking groove 21 and the second locking groove 22 are strip-shaped grooves with a first limit wall surface 23. The locking part 312 has a second limit wall surface 3121 that matches the first limit wall surface. Through the design of the limit wall surface, once the locking part 312 of the slider 31 is locked into the first locking groove 21 and the second locking groove 22, the blade 20 cannot rotate any further, ensuring reliable locking.

The storage slot is provided with a second limiting column 12 for limiting the downward movement of the slider 31. Specifically, the second limiting column 12 is positioned in front of the first limiting column 33 and supports the slider 31 to facilitate positioning and assembly.

The handle 10 has a left side plate and a right side plate, both of which are provided with a travel groove 16 for the pull rod 34. Specifically, the left side plate has a left outer liner 131 and a left inner liner 132, and the right side plate has a right outer liner 141 and a right inner liner 142. Both the left inner liner 132 and the right inner liner 142 are hardware components and are provided with a first avoidance hole 133 for the first limiting column 33 and a second avoidance hole 134 for the second limiting column 12, respectively. By setting the avoidance holes, the thickness of the handle 10 can be reduced, thus improving grip comfort.

Furthermore, the handle 10 is provided with a third limiting column 15 for limiting the upward rotation of the blade 20. The blade 20 is provided with a limit groove 24 for the third limiting column 15, thus preventing the blade 20 from continuing to rotate upward when the blade 20 is deployed in place.

Next, the operation principle of the folding knife in this application will be explained in detail:

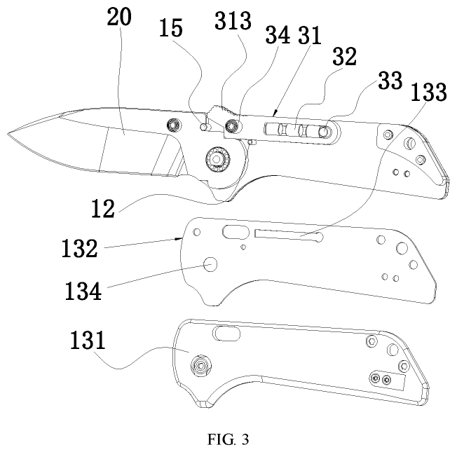

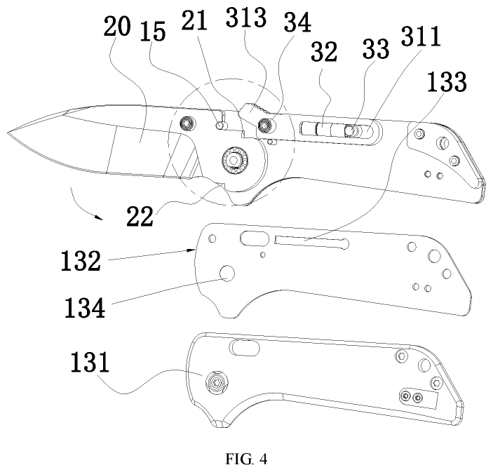

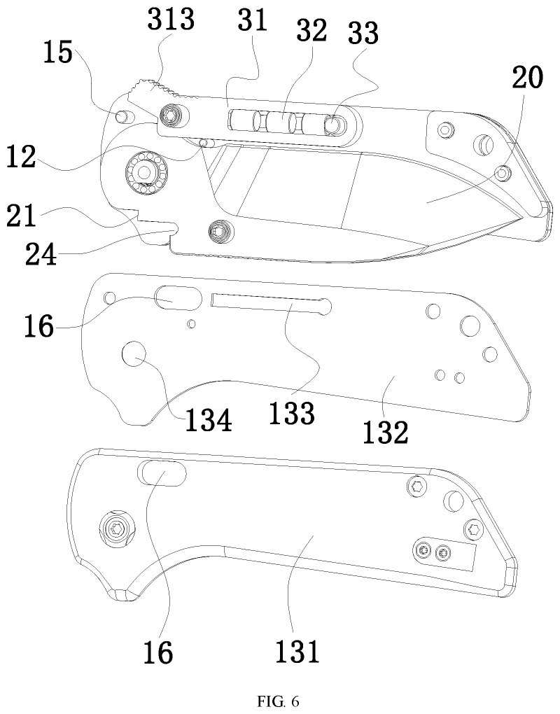

As shown in FIG. 3, the folding knife is in the unfolded and locked state. When it needs to be folded, the protrusion 313 or the pull rod 34 can be flipped to move the slider 31 backward. The locking part 312 of the slider 31 disengages from the first locking groove 21 of the blade 20 (as shown in FIG. 4), allowing the blade 20 to rotate backwards and be stored in the storage slot 11. After that, loosen the protrusion 313 or flip the pull rod 34 to move the slider 31 forward. The locking part 312 of the slider 31 engages with the second locking groove 22 of the blade 20, thereby locking the folding knife in the folded state (as shown in FIG. 6).

As shown in FIG. 6, when the folding knife is folded and locked, the protrusion 313 or the pull rod 34 is flipped to make the slider 31 to move backwards. The locking part 312 of the slider 31 disengages from the second locking groove 22 of the blade 20, allowing the blade 20 to rotate forward. When the third limiting column 15 contacts the limit groove 24 of the blade 20, loosen the protrusion 313 or flip the pull rod 34 to move the slider 31 forward. The locking part 312 of the slider 31 engages with the first locking groove 21 of the blade 20, thereby locking the folding knife in the unfolded state.

The design focus of the present invention is to provide a convenient unlocking mechanism for users to select different unlocking methods according to their needs, mainly through the protrusion and pull rod extending on the slider, which improves usability and product playability. Moreover, the locking structure designed in this application is reasonable, stable, reliable, and easy to assemble. Additionally, the magnetic element is used as the resetting component to make the knife not easy to lose and rust and facilitate dismantling, maintenance, and repair operations by users.

The above description is merely the preferred embodiment of the present invention, and is not intended to limit the scope of the invention. Therefore, any slight modifications, equivalent changes, and modifications made to the above embodiments based on the technical essence of the present invention are still within the scope of the technical solution of the present invention.

What is claimed is:

1. A folding knife with different unlocking modes, comprising a handle and a blade that can be folded and stored inside the handle, is characterized in that it has a storage slot for the blade, and the storage slot is adjustably provided with a locking buckle; the blade has a first locking groove and a second locking groove that are adapted to the locking buckle: specifically:
The locking buckle includes a slider, a resetting component, and a first limiting column; the first limiting column is installed in the storage slot and the slider is provided with a sliding groove extending forward and backward for the first limiting column: the resetting component is arranged inside the sliding groove;
the slider is provided with a locking part that is adapted to the first locking groove and the second locking groove: the slider has a protrusion extending obliquely upwards, and a pull rod is set on the left and/or right side of the slider; the pull rod extends to the outside of the handle;
the resetting component is composed of several mutually exclusive and arranged magnetic components.

2. A folding knife with different unlocking modes as described in claim 1 is characterized in that the first locking groove and the second locking groove are strip-shaped grooves, and the strip-shaped grooves have a first limit wall surface; the locking part has a second limit wall surface that is adapted to the first limit wall surface.

3. A folding knife with different unlocking modes as described in claim 2 is characterized in that the storage slot is provided with a second limiting column for limiting the downward movement of the slider.

4. A folding knife with different unlocking modes as described in claim 3 is characterized in that the handle has a left plate and a right plate, with the left plate having a left outer liner and a left inner liner, and the right plate having a right outer liner and a right inner liner;
the left inner liner and the right inner liner are both hardware components, and both have a first avoidance hole for the first limiting column and a second avoidance hole for the second limiting column.

5. A folding knife with different unlocking modes as described in claim 3 is characterized in that the a third limiting column is provided on the handle to limit the upward rotation of the blade, and a limit groove is provided on the blade for the third limiting column.

6. A folding knife with different unlocking modes as described in claim 3 is characterized in that the protrusion has friction patterns.

7. A folding knife with different unlocking modes as described in claim 3 is characterized in that the front and rear sides of the slider are both provided with pull rods, and the pull rods are connected to the slider through connecting screws.
